(19) United States
(12) Patent Application Publication
(10) Pub. No.: US 2023/0102341 A1
(43) Pub. Date: Mar. 30, 2023

(54) ELECTRONIC DEVICE AND METHOD FOR IDENTIFYING SERVICE ACCESS

(71) Applicant: Fulian Precision Electronics (Tianjin) Co., LTD., Tianjin (CN)

(72) Inventor: CHI-CHUN CHIANG, New Taipei (TW)

(21) Appl. No.: 17/566,257

(22) Filed: Dec. 30, 2021

(30) Foreign Application Priority Data
Sep. 29, 2021 (CN) 202111150658.7

(51) Int. Cl. H04L 9/40; H04L 9/32

(52) U.S. Cl. CPC H04L 63/0815; H04L 9/3213

(57) ABSTRACT

A method for identifying service access implemented in an electronic device includes in response to a user's login request, receiving login information of the user, and performing a first-stage identification on the login information based on a front-end identification mechanism; in response that the login information is determined to be authenticated, generating a token corresponding to the login information, the token providing a read permission of at least one second-stage credential; transmitting the at least one second-stage credential of the user to the terminal device according to the token and the login information; performing a second-stage identification on at least one second-stage credential to be identified based on at least one back-end identification mechanism; and in response that the at least one second-stage credential to be identified is determined to be authenticated, accepting the user's request for accessing at least one platform service.

### FIELD

The subject matter herein generally relates to service access management, and particularly to an electronic device and a method for identifying service access.

### BACKGROUND

With a development of cloud computing centers, cloud storage, and big data, platforms or services such as GOOGLE, AMAZONE, AZURE, GITHUB are equipped with account and password identification mechanisms or service identification mechanisms, developers need to design a back-end identification service in a developing phase. Single Sign On (SSO) is a commonly used identification mechanism, which adopts a single entry architecture. However, the SSO mechanism also requires to be integrated in the design phase of the back-end service. As a result, only various types of front-end identification mechanisms can be added in the SSO architecture, however, various types of back-end identification mechanisms cannot be added, which results in lack of flexibility of the identification service, and is inconvenient to identify user access multiple platforms or services.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an embodiment of an application environment of an electronic device according to the present disclosure.

FIG. 2 illustrates a flowchart of an embodiment of a process of user registration according to the present disclosure.

FIG. 3 illustrates a block diagram of an embodiment of a process of user registration according to the present disclosure.

FIG. 4 illustrates a flowchart of an embodiment of a method for identifying service access according to the present disclosure.

FIG. 5 illustrates a block diagram of an embodiment of a first stage identification in a process of user login according to the present disclosure.

FIG. 6 illustrates a block diagram of an embodiment of a second stage identification in the process of user login according to the present disclosure.

FIG. 7 is a block diagram of an embodiment of the electronic device according to the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or another storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

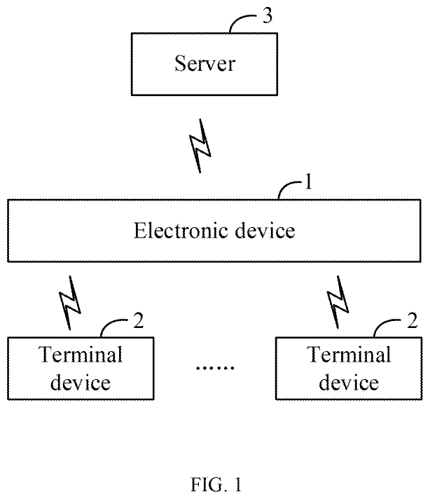

Referring to FIG. 1, an electronic device 1 is illustrated. In one embodiment, the electronic device 1 communicates with at least one terminal device 2 and a server 3 through a network. The network can be a wired network or a wireless network. The wireless network can be radio, WI-FI, or cellular network. The cellular network can be a 4G network or a 5G network.

The electronic device 1 may be an electronic device with a service access identification program installed, such as a personal computer, a server, etc., the server may be a single server, a server cluster, or the like. In other embodiments, the electronic device 1 may also be a sensitive database constituted by at least one server. The server 3 may be a single server, a server cluster, or the like.

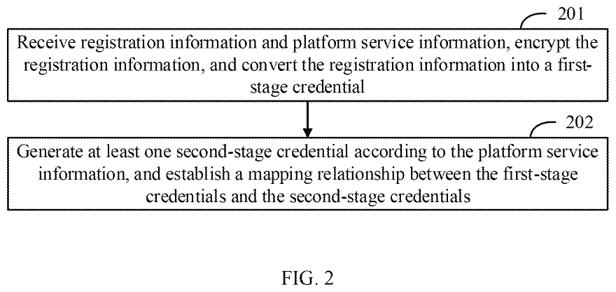

FIG. 2 illustrates a flowchart of an embodiment of a process of user registration. The method is provided by way of example, as there are a variety of ways to carry out the method. Each block shown in FIG. 2 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 201.

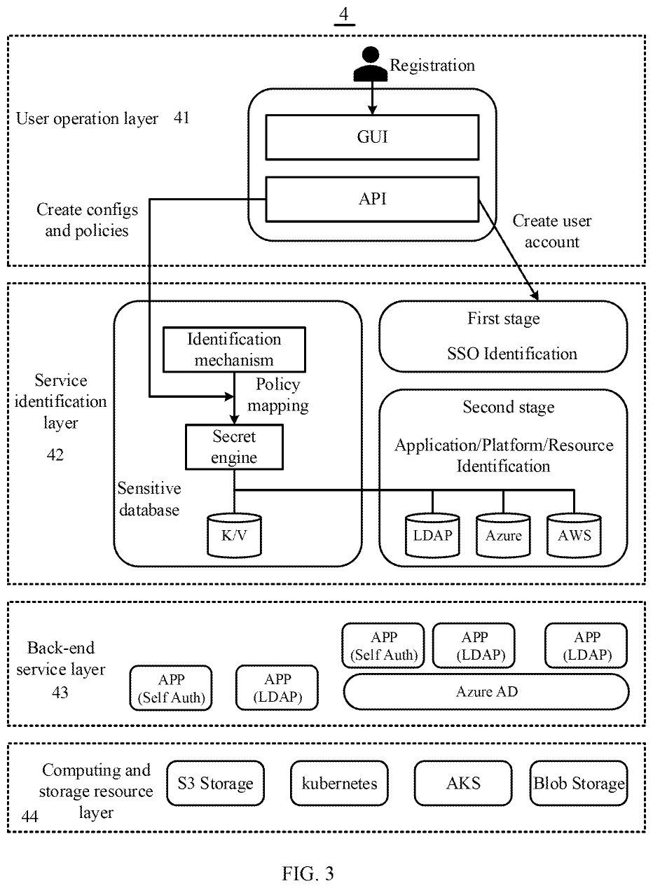

Referring to FIG. 3, an embodiment of the method for identifying service access is described by using a service access identification architecture 4. The service access identification architecture 4 includes a user operation layer 41, a service identification layer 42, a back-end service layer 43, and a computing and storage resource layer 44.

At block 201, in response to a user's registration request from a terminal device, receive registration information and platform service information transmitted by the terminal device, encrypt the registration information, and convert the registration information into a first-stage credential.

As illustrated in FIG. 3, at the user operation layer 41, the user can input the registration information and the platform service information, and submit the registration request through a graphical user interface (GUI) of the terminal device 2. The GUI may be an interface that integrates at least one platform service program. For example, the platform services corresponding to at least one platform service program may include simple storage services (S3 STORAGE) and MICROSOFT cloud services (WINDOWS AZURE). The user can access a number of platform services through the integrated platform service programs.

In one embodiment, the registration information at least includes a first account name and a first password of the user. The password can be in a form of characters, such as a combination of at least one of letters, numbers, and symbols, or can be biometric information, such as fingerprints, iris, or facial images.

In one embodiment, based on the network, the terminal device 2 transmits the registration information to the electronic device 1 (i.e., sensitive database) through an Application Programming Interface (API), and the registration information is encrypted and converted into the first-stage credential by the electronic device 1.

In detail, at the service identification layer 42, the electronic device 1 receives the registration information transmitted by the terminal device 2, creates a user account based on the registration information, encrypts the first account name and first password according to Lightweight Directory Access Protocol (LDAP), and records the first account name and first password in an OU:SSO logical group of the LDAP, thereby converting the first account name and first password into the identification information in the OU:SSO logical group of the LDAP, and the identification information in the OU:SSO logical group is the single sign-on credential of the user, a single sign-on mechanism is thus established for the user account. In one embodiment, the first-stage credentials are stored in a secret engine of the electronic device 1.

At block 202, generate at least one second-stage credential of at least one platform service according to the platform service information, and establish a mapping relationship between the first-stage credentials and the second-stage credentials.

In one embodiment, the platform service information includes a name of the at least one platform service that the user can access, second stage identification information including a second account name and a second password of each of the at least one platform service is automatically generated according to the at least one platform service name. The automatically generated second account name may be the same as or different from the first account name of the first-stage credential, the automatically generated second password is different from the first password of the first-stage credential, and the second passwords of different platform services are also different. In this way, the electronic device 1 can automatically generate the second stage identification information for each platform service, and manage the second stage identification information of each platform service for the user.

In other embodiments, the platform service information includes the at least one name of the platform service that the user can access, and the second stage identification information including the second account name and second password of each of the at least one platform service. In this way, the second stage identification information is submitted by the user, the electronic device 1 only manage the second stage identification information of each platform service for the user. In one embodiment, the second stage identification information are stored in the secret engine of the electronic device 1.

In one embodiment, the second stage identification information is encrypted based on the identification mechanism of each platform service. In detail, the second account name and second password in the second stage identification information are encrypted based on the LDAP, that is, record the second account name and second password in the second stage identification information in an OU:USERS logical group of the LDAP, the second account name and second password are thus converted into the identification information in the OU:USERS logical group of LDAP. The identification information in the OU:USERS logical group of LDAP is determined as the second-stage credential of each of the at least one platform service that the user can access.

In other embodiments, the second account name and second password in the second-stage credential may also be converted into a key/value group (e.g., the account name and password stored in S3 STORAGE or WINDOWS computing platform in a key/value format) or the account name and password of AZURE (e.g., AZURE PUBLIC CLOUD identification mechanism). The key/value group or the account name and password of AZURE are determined as the second-stage credential of each of the at least one platform service that the user can access.

In one embodiment, after at least one second-stage credential is generated, establish the mapping relationship between the first-stage credentials and the second-stage credentials, that is, establish the mapping relationship between a group of the first account name and first password of the user for single sign-on and at least one group of the second account name and second password of at least one platform service that the user can access, and stores the mapping relationship in the secret engine. The electronic device creates configuration files to record the mapping relationship between the first-stage credentials and the second-stage credentials based on the user's registration information and platform service information, so as to generate a policy mapping of the user's identity identification.

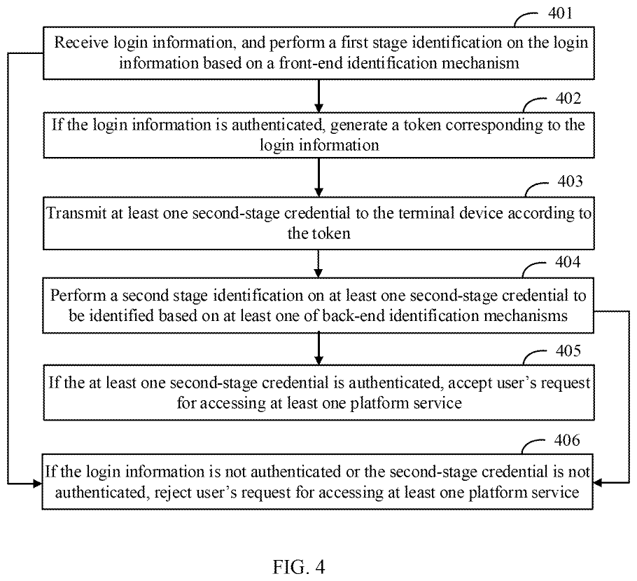

FIG. 4 illustrates a flowchart of an embodiment of a method for identifying service access. The method is provided by way of example, as there are a variety of ways to carry out the method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 401

At block 401, in response to a user's login request, receive login information of the user, and perform a first stage identification on the login information based on a front-end identification mechanism.

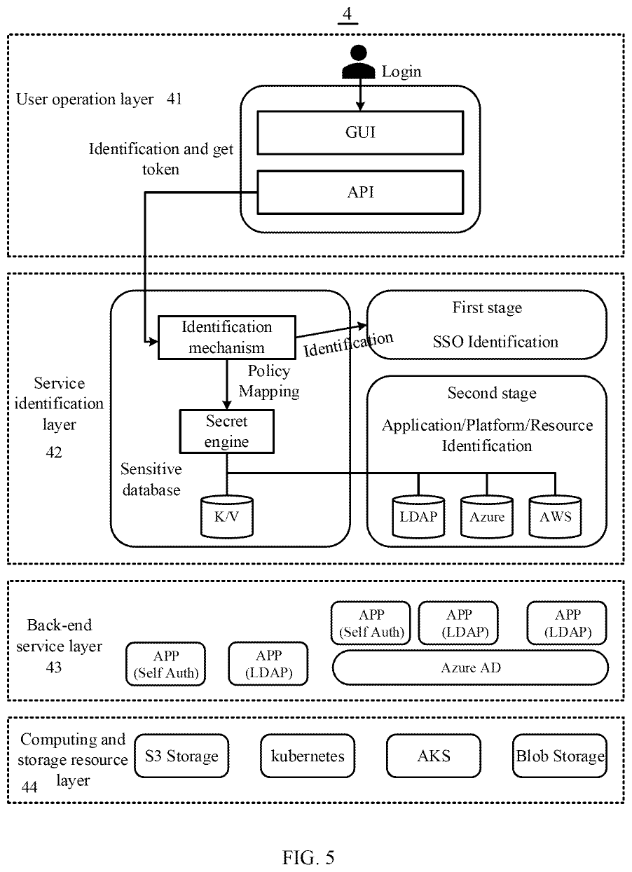

Referring to FIG. 5, at the user operation layer 41, the user can input the login information and platform service information through the GUI of the terminal device 2, and submit the login request. In one embodiment, the login information at least includes an account name and a password to be identified. The password to be identified can be in a form of characters, or biometric information, such as fingerprints, iris, facial images.

Then, based on the network, the terminal device 2 transmits the login information and the platform service information to the electronic device 1 through the API, and the electronic device 1 identifies the login information based on a front-end identification mechanism. In one embodiment, the front-end identification mechanism is an SSO identification, and can be integrated in the electronic device in a form of key/value group.

In detail, the front-end identification mechanism is realized by the logical group OU:SSO in the LDAP, the login information is identified based on the front-end identification mechanism by comparing the account name and password to be identified in the login information with the first-stage credentials stored in the storage device, that is, the first account names and first passwords in the OU:SSO logical group of LDPA, determining whether the login information matches at least one of the first-stage credentials, that is, determining whether the account name to be identified in the login information is the same as a first account name of at least one of the first-stage credentials, and determining whether the password to be identified in the login information is the same as a first password of the same first-stage credential. If it is determined that the login information matches the at least one of the first-stage credentials, that is, if the account name to be identified in the login information is the same as a first account name of at least one of the first-stage credentials, and the password to be identified in the login information is the same as a first password of the same first-stage credential, determine that the login information is authenticated. If it is determined that the login information does not match any one of the first-stage credentials, that is, that is, if the account name to be identified in the login information is not the same as any first account name of the at least one of the first-stage credentials, and/or the password to be identified in the login information is not the same as any first password of the same first-stage credential, determine that the login information is not authenticated.

At block 402, if the login information is authenticated, generate a token corresponding to the login information.

In one embodiment, the token is used to provide a read permission of the second-stage credential. The token is a character string generated by the electronic device 1, and is a credential for the terminal device 2 to transmit a second-stage identification request. If the login information is authenticated, the terminal device 2 transmits a request for acquiring the token, the electronic device 1 randomly generates the token and transmits the token to the terminal device 2. The terminal device 2 can request data from the electronic device 1 based on the token, without re-submitting the account name and password.

In detail, the terminal device 2 can store the token transmitted by the electronic device in a temporary identity file (Cookie) or local database (Local Storage), the terminal device 2 is required to carry the token while requesting data or resources from the electronic device 1, and the electronic device 1 verifies the token carried in the request when receiving the request from the terminal device 2, if the token is verified, the request can be responded, and if the token is not verified, the electronic device 1 transmits an error message to the terminal device 2. In addition, the electronic device 1 may also define a validity period for the token, and each time receive the request from the terminal device 2, the validity period of the token is also required to be verified.

At block 403, transmit at least one second-stage credential of the user to the terminal device according to the token.

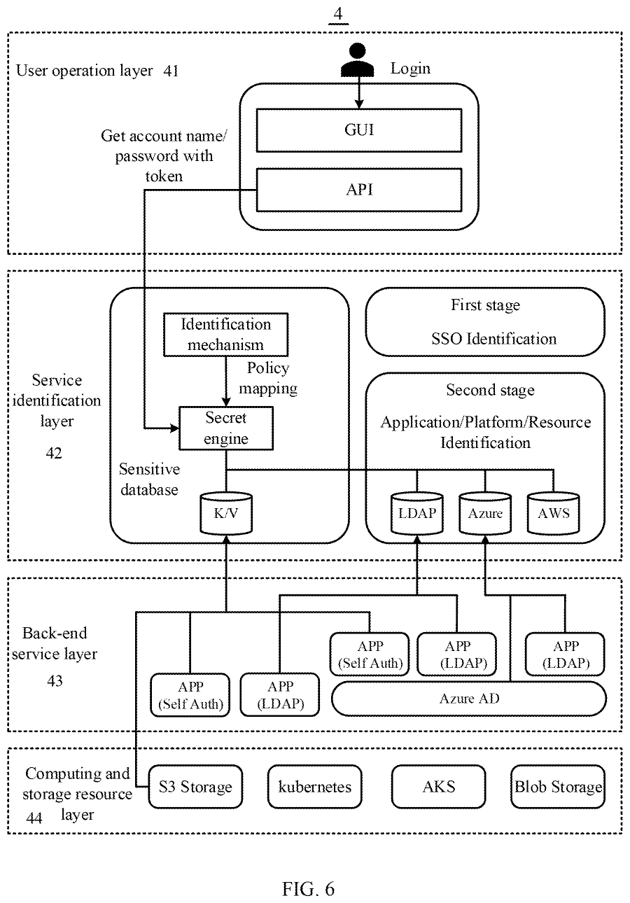

Referring to FIG. 6, in one embodiment, the API of the terminal device 2 queries the secret engine of the electronic device based on the token and the first-stage credential, and requests at least one second-stage credential corresponding to the first-stage credential of the user. The electronic device 1 determines the at least one second-stage credential of the platform service that the user requests to access corresponding to the first-stage credential based on the mapping relationship between the first-stage credentials and the second-stage credentials, and transmits the determined at least one second-stage credential of the platform service that the user requests to access to the terminal device. In one embodiment, the second-stage credential is the second account name and second password recorded in the OU:USERS logical group of the LDAP.

In one embodiment, the platform service information in the login information includes the name of the at least one platform service to be accessed by the user. The API of the terminal device 2 can acquire the at least one second-stage credential of the platform service corresponding to the name of the at least one platform service to be accessed.

At block 404, perform a second stage identification on at least one second-stage credential to be identified transmitted by the terminal device based on at least one back-end identification mechanism.

In one embodiment, the back-end identification mechanisms are identification mechanisms provided by various types of platform services accessed by the electronic device, and are connected with the electronic device 1 as identification services in a form of configuration file.

In detail, when the terminal device requests the second stage identification for accessing the platform service, the terminal device transmits the second-stage credential to be identified to the electronic device. The second stage identification is performed on the second-stage credential to be identified based on the at least one back-end identification mechanism includes: acquire the at least one second-stage credential to be identified transmitted by the API of the terminal device 2, and identify the at least one second-stage credential to be identified through the identification mechanism provided by the platform service corresponding to the name of the at least one platform service to be accessed. If the identification mechanism provided by the platform service corresponding to the name of the platform service to be accessed determines that the second-stage credential to be identified is the same as at least one second-stage credential in the platform service, determine that the second-stage credential is authenticated. If the identification mechanism provided by the platform service corresponding to the name of the platform service to be accessed determines that the second-stage credential to be identified is not the same as any one of the second-stage credentials in the platform service, determine that the second-stage credential is not authenticated.

In detail, at the back-end service layer 43, the LDAP service provided by the LDAP program identifies the second-stage credential based on the LDAP identification mechanism. The identification service provided by the self-authentication (Self Auth) program identifies the second-stage credential based on the key/value group identification mechanism, and the S3 STORAGE or container (KUBERNETES) provides the computing resources at the computing and storage resource layer 44. The platform services provided by the LDAP program based on WINDOW AZURE and the Active Directory program (WINDOWS AZURE AD) identify the second-stage credential based on the AZURE identification mechanism, and Microsoft Containers (AZURE KUBERNETES, AKS) or unstructured storage services (Blob Storage) provides the computing resources at the computing and storage resource layer 44. In one embodiment, the computing and storage resource layer 44 runs in the server 3.

At block 405, if the second-stage credential is authenticated, accept the user's request for accessing the at least one platform service.

In one embodiment, if the at least one second-stage credential is authenticated, the user's request for accessing the platform service is accepted, and the terminal device 2 can access the at least one platform service corresponding to the at least one authenticated second-stage credential through the API. Then, the API of the terminal device 2 can access at least one back-end service by using the at least one second-stage credential, the user is not required to re-submit any other account name or password.

At block 406, if the login information is not authenticated, or the second-stage credential is not authenticated, reject the user's request for accessing the at least one platform service.

In one embodiment, if the login information is not authenticated in the first-stage or second-stage identification, users do not have permission to access the at least one platform services, thus, the user's request for accessing the at least one platform service is rejected. If the electronic device does not acquire the second-stage credential transmitted by the terminal device 2, that is, the second-stage credential corresponding to any one of the platform services to be accessed is not acquired by the terminal device 2, the user's request for accessing the at least one platform service is also rejected.

By applying the method for identifying service access, the user only needs to remember the account name and password of single sign-on, the front-end identification mechanism can identify the account name and password submitted by the user, and various back-end identification mechanisms can identify the user access according to the account name and password, the user do not need to submit various account names or passwords for various platform services. As the number of platform services increases, the burden of the user for remembering credentials will not increase.

By applying the method for identifying service access, the service developers can retain their own front-end identification mechanism, and store the front-end identification mechanism in the sensitive database through key/value groups, and can further replaces the program codes of the back-end identification mechanism with a configuration file (Config). The configuration file can be easily modified, and the back-end identification mechanism in the form of configuration file can be easily integrated with the front-end identification mechanism. In addition, the service developers can access a shareable second-stage identification mechanism such as LDAP as a main identification mechanism for single sign-on, copies of account and password are reduced, security is increased, and costs of development and database maintenance are reduced.

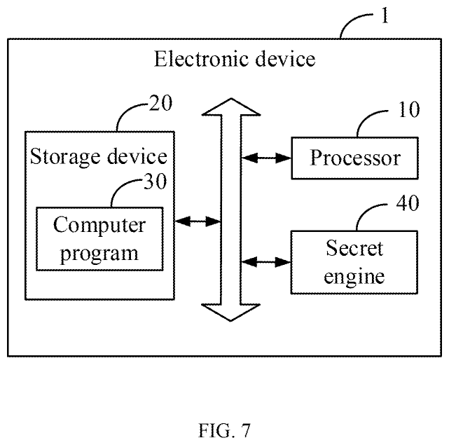

FIG. 7 illustrates the electronic device 1 in one embodiment. The electronic device 1 includes, but is not limited to, a processor 10, a storage device 20, a computer program 30, and a secret engine 40. FIG. 7 illustrates only one example of the electronic device 1. Other examples can include more or fewer components than as illustrated or have a different configuration of the various components in other embodiments.

The processor 10 can be a central processing unit (CPU), a microprocessor, or other data processor chip that performs functions in the electronic device 1.

In one embodiment, the storage device 20 can include various types of non-transitory computer-readable storage mediums. For example, the storage device 20 can be an internal storage system, such as a flash memory, a random access memory (RAM) for the temporary storage of information, and/or a read-only memory (ROM) for permanent storage of information. The storage device 20 can also be an external storage system, such as a hard disk, a storage card, or a data storage medium.

The storage device 20 stores instructions, the processor 10 executes the instructions stored in the storage device 20, and the instructions can be used for implementing the method for identifying service access provided in the embodiments of the present disclosure.

The secret engine 40 is a program integrated in the electronic device 1, which may be connected to the terminal device 2 through an application programming interface and multiple platform services, and identify the second-stage credential through the identification mechanism of the multiple platform services, and provide the terminal device 2 of the user with the access service of the platform service.

The processor 10 is configured to:

in response to a user's registration request, receive registration information and platform service information, encrypt the registration information, and convert the registration information into a first-stage credential;

generate a second-stage credential of at least one platform service according to the platform service information, and establish a mapping relationship between the first-stage credentials and the second-stage credentials;

in response to a user's login request, receive login information of the user, and perform a first-stage identification on the login information based on a front-end identification mechanism;

if the login information is authenticated, generate a token corresponding to the login information;

transmit at least one second-stage credential to the terminal device according to the token;

perform a second-stage identification on at least one second-stage credential transmitted by the terminal device based on at least one back-end identification mechanism;

if the second-stage credential is authenticated, accept the user's request for accessing the at least one platform service;

if the login information is not authenticated, or the second-stage credential is not authenticated, reject the user's request for accessing the at least one platform service.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. An electronic device comprising:
at least one processor; and
a storage device coupled to the at least one processor and storing instructions for execution by the at least one processor to cause the at least one processor to:
in response to a user's login request from a terminal device, receive login information of the user, and perform a first-stage identification on the login information based on a front-end identification mechanism;
in response that the login information is determined to be authenticated, generate a token corresponding to the login information, wherein the token provides a read permission of at least one second-stage credential;
transmit the at least one second-stage credential of the user to the terminal device according to the token and the login information;
perform a second-stage identification on at least one second-stage credential to be identified transmitted by the terminal device based on at least one back-end identification mechanism; and
in response that the at least one second-stage credential to be identified is determined to be authenticated, accept the user's request for accessing at least one platform service.

2. The electronic device according to claim 1, wherein the at least one processor is further caused to:
in response that the login information or the at least one second-stage credential to be identified is determined to be not authenticated, reject the user's request for accessing the at least one platform service.

3. The electronic device according to claim 1, wherein the at least one processor is further caused to:
in response to a user's registration request from the terminal device, receive registration information and platform service information transmitted by the terminal device, encrypt the registration information, and convert the registration information into a first-stage credential; and
generate the second-stage credential of the at least one platform service according to the platform service information, and establish a mapping relationship between the first-stage credentials and the second-stage credentials.

4. The electronic device according to claim 3, wherein the at least one processor is further caused to:
determine whether the login information matches the first-stage credential;
in response that the login information matches the first-stage credential, determine that the login information is authenticated; and
in response that the login information does not match the first-stage credential, determine that the login information is not authenticated.

5. The electronic device according to claim 4, wherein the at least one processor is further caused to:
in response that the login information is authenticated, acquire the at least one second-stage credential to be identified transmitted by the terminal device according to the login information, and the mapping relationship between the first-stage credentials and the second-stage credentials; and
identify the at least one second-stage credential through at least one identification mechanism of the at least one platform service.

6. The electronic device according to claim 5, wherein the at least one processor is further caused to:
generate second stage identification information; and
generate the second-stage credential of each of the platform services by encrypting the second stage identification information based on the identification mechanism of each of the platform services.

7. The electronic device according to claim 3, wherein the first stage credentials and the second stage credentials are identification information in logical groups of Lightweight Directory Access Protocol.

8. The electronic device according to claim 1, wherein the front-end identification mechanism is integrated in the electronic device in a form of key/value group, and the at least one back-end identification mechanism is identification service provided by the platform service, each of the at least one back-end identification mechanism is accessed to the electronic device in a form of configuration file.

9. A method for identifying service access implemented in an electronic device comprising:
in response to a user's login request from a terminal device, receiving login information of the user, and performing a first-stage identification on the login information based on a front-end identification mechanism;
in response that the login information is determined to be authenticated, generating a token corresponding to the login information, wherein the token provides a read permission of at least one second-stage credential;
transmitting the at least one second-stage credential of the user to the terminal device according to the token and the login information;
performing a second-stage identification on the at least one second-stage credential to be identified transmitted by the terminal device based on at least one back-end identification mechanism; and
in response that the at least one second-stage credential to be identified transmitted by the terminal device is determined to be authenticated, accepting the user's request for accessing at least one platform service.

10. The method according to claim 9, further comprising:
in response that the login information or the at least one second-stage credential to be identified is determined to be not authenticated, rejecting the user's request for accessing the at least one platform service.

11. The method according to claim 9, further comprising:
in response to a user's registration request from the terminal device, receiving registration information and platform service information transmitted by the terminal device, encrypting the registration information, and converting the registration information into a first-stage credential; and
generating the second-stage credential of the at least one platform service according to the platform service information, and establishing a mapping relationship between the first-stage credentials and the second-stage credentials.

12. The method according to claim 11, wherein performing a first-stage identification on the login information based on a front-end identification mechanism comprises:
determining whether the login information matches the first-stage credential;
in response that the login information matches the first-stage credential, determining that the login information is authenticated; and
in response that the login information does not match the first-stage credential, determining that the login information is not authenticated.

13. The method according to claim 12, wherein performing a second-stage identification on at least one second-stage credential transmitted by the terminal device based on at least one back-end identification mechanism comprises:
in response that the login information is authenticated, acquiring the at least one second-stage credential to be identified transmitted by the terminal device according to the login information, and the mapping relationship between the first-stage credentials and the second-stage credentials; and
identifying the at least one second-stage credential through at least one identification mechanism of the at least one platform service.

14. The method according to claim 13, wherein generating the second-stage credential of the at least one platform service according to the platform service information comprises:
generating second stage identification information; and
generating the second-stage credential of each of the platform services by encrypting the second stage identification information based on the identification mechanism of each of the platform services.

15. The method according to claim 11, wherein the first stage credentials and the second stage credentials are identification information in logical groups of Lightweight Directory Access Protocol.

16. The method according to claim 9, wherein the front-end identification mechanism is integrated in the electronic device in a form of key/value group, and the at least one back-end identification mechanism is identification service provided by the platform service, each of the at least one back-end identification mechanism is accessed to the electronic device in a form of configuration file.
